(19) United States
(12) Patent Application Publication
(10) Pub. No.: US 2005/0120153 A1
(43) Pub. Date: Jun. 2, 2005

(54) Computer interconnect system

(76) Inventors: Miguel A. Perez, Tomball, TX (US); Li-Yuan Wang, Houston, TX (US); Yeou-Kai Wu, Houston, TX (US)

Correspondence Address: WEI TE CHUNG;FOXCONN INTERNATIONAL, INC., 1650 MEMOREX DRIVE, SANTA CLARA, CA, 95050, US

(21) Appl. No.: 10/726,945

(22) Filed: Dec. 2, 2003

(51) Int. Cl. G06F 13/10

(52) U.S. Cl. 710/62

(57) ABSTRACT

An interconnect system (100) includes a motherboard (1), a group of cards (21, 22, 23) with different standards, and a group of translation adapters (31, 32, 33). The motherboard defines a number of golden fingers (12) connecting with logic circuits and forming an interface compatible with the different standards. Based on the user's requirement, the cards can be selected to engage the golden fingers of the motherboard through corresponding adapters. Each adapter includes a board-mating connector (30) mating with golden fingers and has an interface engaging with corresponding cards.

### BACKGROUND OF THE INVENTION

1. Field of the Invention

The present invention generally relates to a computer interconnect device, and particularly to an interconnect device for connecting a selected type of card to a motherboard based on customer's requirement.

2. Description of Related Art

The demands of emerging computing and communications platforms exceed the capabilities of the traditional PCI (Peripheral Component Interconnect) bus. Technical innovations such as 10 GHz+ CPU speeds, faster memory, high-performance graphics, gigabit networking, high-speed consumer devices and other market requirements will drive the need for much greater internal system bandwidth. The PCI Express architechture is a low-cost, highly scalable, general-purpose serial I/O interconnect that provides a unifying standard for consolidating a number of I/O solutions within a platform. For example, PCI Express can be used to replace the existing PCI, AGP (Accelerated Graphics Port) and core logic interconnects. At present, PCI Express slots can co-exist with PCI and PCI-X and actual platform implementations will be determined by OEMs and IHVs.

However, when more than two types of interfaces, such as PCI and PCI Express or other type of interface, are presented together in the computer, the different types of slots which allow for connecting different types of interfaces to satisfy different users requirements will make the computer more bigger than needed.

Hence, an improved interconnect device is highly desired to overcome the disadvantages of the related art.

### BRIEF SUMMARY OF THE INVENTION

Accordingly, it is an object of the present invention to provide an interconnect device which has a translation adapter for the user connecting the desired application card to a single common interface compatible with different Input/Output interfaces.

In order to achieve the above-mentioned object, an interconnect system in accordance with the present invention comprises a motherboard, a group of cards conforming to different signal transmission standards, and a group of translation adapters. The motherboard defines a plurality of golden fingers connecting with logic circuits and forming an interface compatible with the different standards. Based on the user's requirement, the cards can be selected to engage the golden fingers of the motherboard through corresponding adapters. Each adapter includes a board-mating connector mating with golden fingers, a card-mating connector mating with the desired card, and a circuit board interconnecting the board-mating connector and the card-mating connector.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a partially exploded, perspective view of an interconnect system in accordance with a first embodiment of the present invention;

FIG. 2 is a perspective view of the interconnect system showing a PCI-Express card assembled on a motherboard;

FIG. 3 is perspective view of the interconnect system showing a PCI card assembled on the motherboard;

FIG. 4 is a perspective view of the interconnect system showing a NewCard assembled on the motherboard;

FIG. 5 is a partially exploded, perspective view of the interconnector system in accordance with a second embodiment of the present invention;

FIG. 6 is a perspective view of the interconnect system showing a PCI-Express card assembled on the motherboard of the second embodiment;

FIG. 7 is a perspective view of the interconnector system showing a PCI card assembled on the motherboard of the second embodiment; and

FIG. 8 is a perspective view of the interconnector system showing a NewCard assembled on the motherboard of the second embodiment.

### DETAILED DESCRIPTION OF THE PREFERRED EMBODIMENT

Reference will now be made to the drawing figures to describe the present invention in detail.

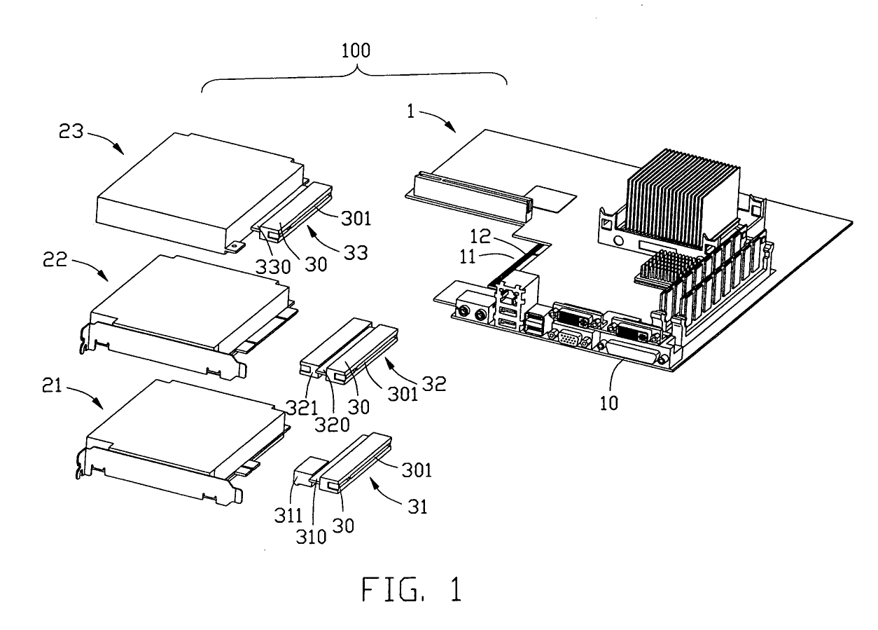

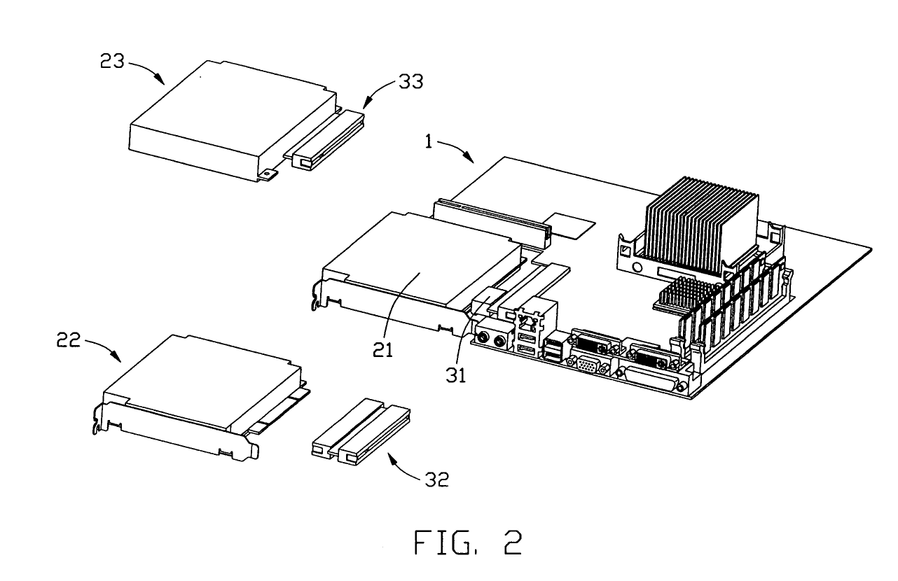

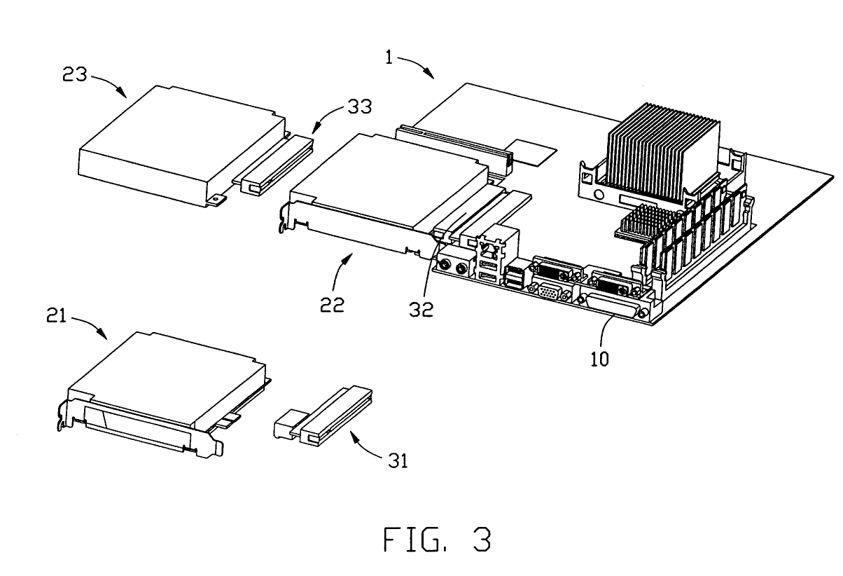

FIGS. 1-4 illustrate an interconnect system 100 in accordance with a first embodiment of the present invention. The interconnect system 100 comprises a motherboard 1 having a plurality of electronic components arranged thereon, a group of interconnect adapters, and a group of application cards.

The motherboard 1 defines a mating side 10 along which a plurality of Input/Output connectors (not labeled) are arranged for electrically connecting with corresponding complementary connectors. A cutout 11 is defined in a lateral side of the motherboard 1 perpendicular to the mating side 10. A plurality of golden fingers 12 are formed on an inner side edge of the cutout 11. The golden fingers 12 conductively connect with logic electrical circuits (not shown) printed on the motherboard 1.

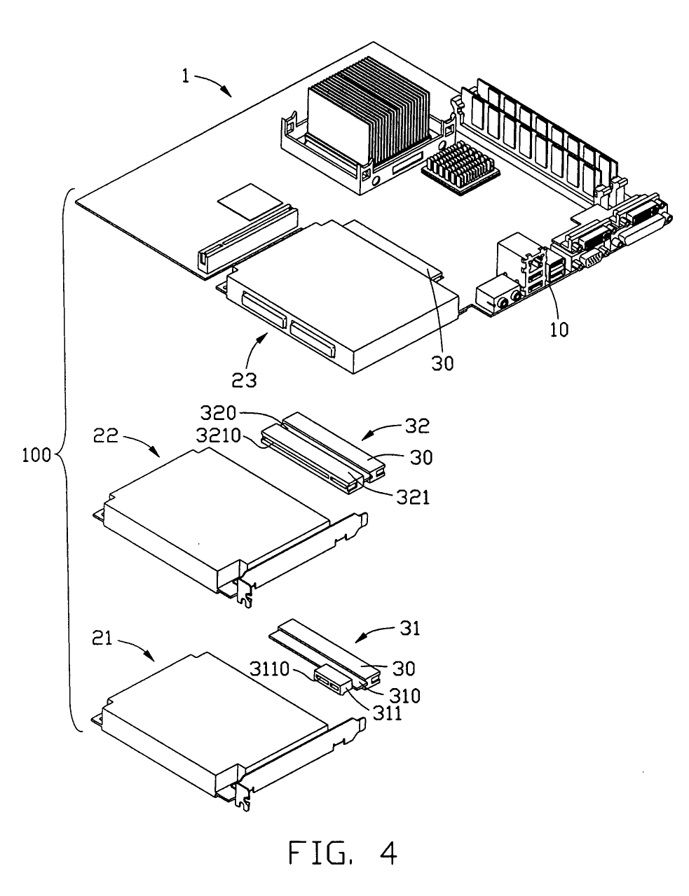

In the preferred embodiment, the group of application cards includes a PCI-Express card 21, a PCI card 22, and a third type of card 23 conforming to a different signal transmission standard, which is called NewCard here. The group of interconnect adapters includes a first, a second and a third translation adapters 31, 32, 33. The first adapter 31 comprises a board-mating connector 30, a translation circuit board 310, and a card-mating connector 311. The board-mating connector 30 has a receiving slot 301 interfacing with the golden fingers 12, while the card-mating connector 311 has a PCI-Express slot 3110 (FIG. 4) engaging with the PCI-Express card 21. The translation circuit board 310 has logic circuits printed thereon which transmit data between the motherboard 1 and the PCI-Express card 21.

Similarly, the second and the third translation adapters 32, 33 have the same board-mating connector as the first translation adapter 31. The second translation adapter 32 also includes a card-mating connector 321 and a translation circuit board 320 interconnecting the card-mating connector 321 with the board-mating connector 30. The card-mating connector 321 of the second adapter 32 has a PCI slot 3210 engaging with the PCI card 22. The board-mating connector 30 of the third translation adapter 33 directly connects with the NewCard, which also functions as a card-mating connector. It should be noted here that the translation circuit boards 310, 320 each have different logic circuits arranged thereon to thereby transmitting different data between the motherboard 1 and respective application cards 21, 22.

In application, based on the user's requirement, the PCI-Express card 21, the PCI card 22 and the NewCard 23 can be selectively engaging with the motherboard 1 via corresponding translation adapters 31, 32, 33.

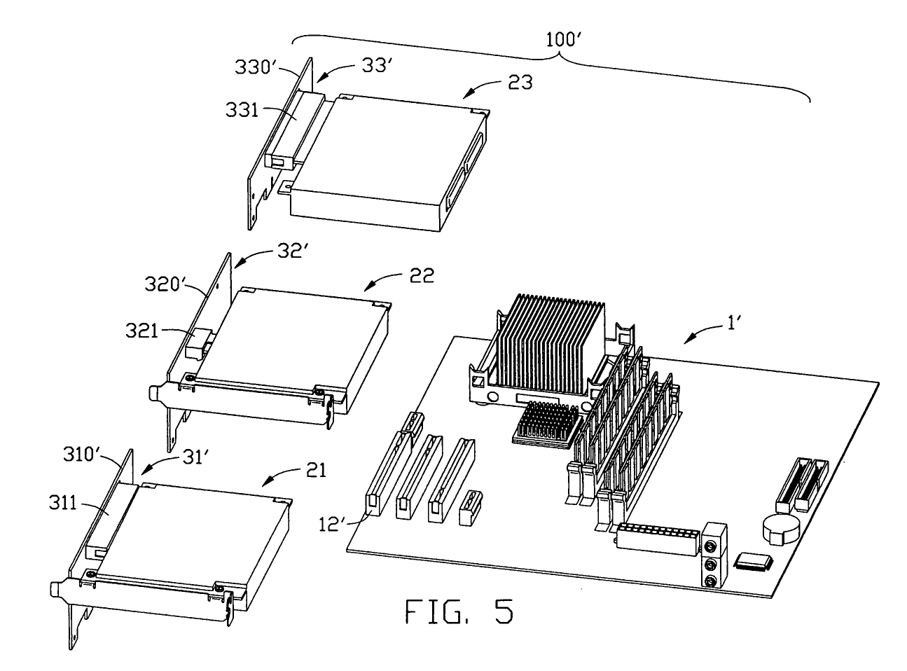

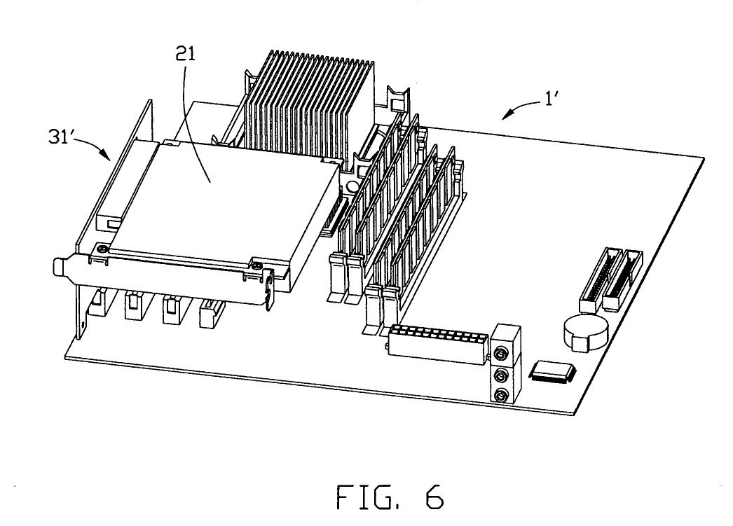

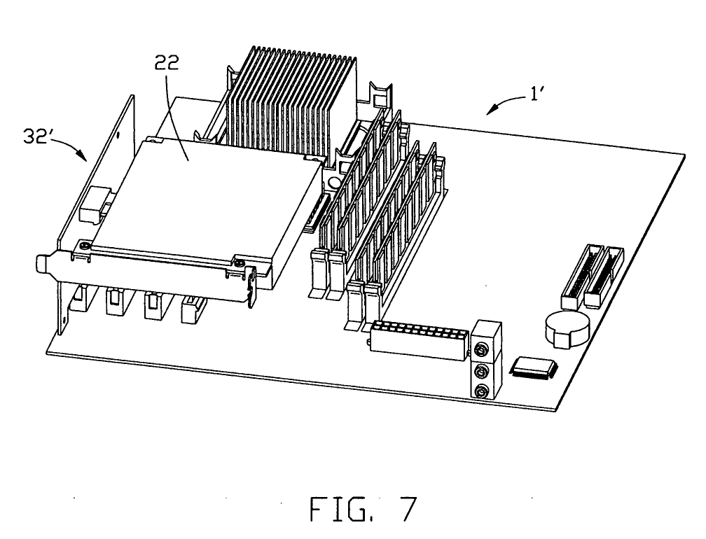

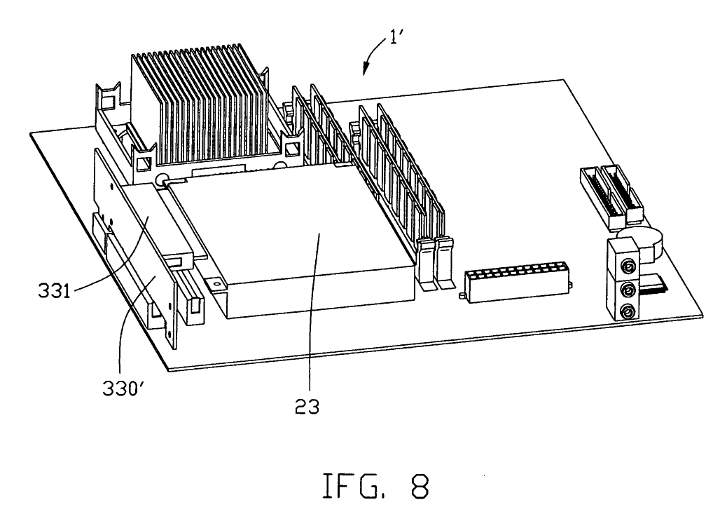

Referring to FIGS. 5-8, a second embodiment of the present invention is illustrated. The interconnect system 100′ of the second embodiment comprises a motherboard 1′, a group of translation adapters and a group of application cards. The motherboard 1′ has similar configuration to the motherboard 1 of the first embodiment except that an extended PCI connector 12′ is arranged on the motherboard 1′ instead of golden fingers 12. The group of application cards includes PCI-Express card 21, PCI card 22 and NewCard 23. Correspondingly, the group of translation adapters includes a first, a second and a third adapters 31′, 32′, 33′. The group of adapters 31′, 32′, 33′ each have a card-mating connector 311, 321, 331 which is same to that of the first embodiment. It should be noted here that the card-mating connector 331 of the third adapter 33′ is same to the board-mating connector 30 of the third adapter 33 in accordance with the first embodiment. Correspondingly, each adapter 31′, 32′, 33′ also comprises a translation circuit board 310′, 320′, 330. The translation circuit boards 310′, 320′, 330′ of the second embodiment have respective logic circuits (not shown) arranged thereon and mating edges (not labeled) engaging with the extended PCI connector 12′, respectively. In application, the three application cards 21, 22, 23 can selectively attached to the motherboard 1′ via corresponding translation adapters 31′, 32′, 33′ as desired by the user.

Obviously, the present invention provides the user great convenience to select the desired application card attached to the motherboard to perform desired functions. Simultaneously, instead of having different slots for use with different interfaces which occupy much more limited space on the motherboard, the present invention provides a single common interface compatible with different signal transmission standards, to which the user can connect the desired application card through corresponding translation adapter.

Accordingly, it is clear that the interconnect from the motherboard could be any of the following: a) golden fingers; b) a connector interface which houses the standard interconnects (such as PCI, PCI-Express, etc.); c) a combination of connectors and/or cables which carry signals for the interface for the proper application riser connect.

Understandably, no matter the board-mating connector or the card-mating connector, each connector traditionally comprises a housing and conductive terminals received in the housing. The details of the connector will not be described here for it is conventional for a person having ordinary skill in the art. Additionally, in most of cases, each card generally has data transmitting ports arranged thereon, such as RJ45 or audio/video ports. In the present invention, these ports are not presented on the corresponding card for they are not necessary for describing subject matter of the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An interconnect system comprising:
a circuit board comprising a first interface compatible with at least two signal transmission standards;
an electronic component having a second interface conforming to one of the at least two standards; and
a translation adapter interconnecting the circuit board and the electronic component, the translation adapter having a board-mating interface interfacing with the first interface and a component-mating interface interfacing with the second interface.

2. The interconnect system as described in claim 1, wherein the circuit board comprises a plurality of electronic elements arranged thereon.

3. The interconnect system as described in claim 2, wherein the circuit board defines a mating side and has a plurality of Input/Output connectors arranged along the mating side.

4. The interconnect system as described in claim 1, wherein the electronic component is an electrical card.

5. The interconnect system as described in claim 1, wherein the translation adapter comprises a first connector having the board-mating interface, a second connector having the component-mating interface, and a board interconnecting the first and the second connectors.

6. The interconnect system as described in claim 1, wherein the circuit board has a plurality of golden fingers forming the first interface.

7. The interconnect system as described in claim 1, wherein the circuit board has an electrical connector having the first interface therewith.

8. An interconnect system assembly comprising:
a circuit board defining a base interface thereof;
first and second electronic components different from each other and respectively defining different first and second interfaces thereof;
first and second adapters different from each other, the first adapter defining a board-mating interface adapted to be mated with the base interface and a first component-mating interface opposite to said board-mating interface and adapted to be mated with the first interface, and the second adapter defining another board-mating interface similar to said board-mating interface and a second component-mating interface opposite to said another board-mating interface and adapted to be mated with the second interface, said first component-mating interface being different from said second component-mating interface; wherein
said first component along with the first adapter and said second component along with the second adapter are mutually exclusively assembled with the circuit board.
